(19) United States
(12) Patent Application Publication
(10) Pub. No.: US 2008/0062195 A1
(43) Pub. Date: Mar. 13, 2008

(54) METHOD FOR COORDINATED DRAWING REVIEW OF REALTED CAD DRAWINGS

(76) Inventors: Hans Fredrick Brown, Montreal (CA); Dianne Phillips, Bow, NH (US); Scott Reinemann, Hooksett, NH (US)

Correspondence Address: PATTERSON & SHERIDAN, L.L.P., 3040 POST OAK BOULEVARD, SUITE 1500, HOUSTON, TX, 77056, US

(21) Appl. No.: 11/470,936

(22) Filed: Sep. 7, 2006

(51) Int. Cl. G09G 5/00

(52) U.S. Cl. 345/619

(57) ABSTRACT

Embodiments of the invention provide methods for performing coordinated drawing review of related CAD drawings. In general, a user may select a review drawing to compare with a project drawing. Once selected a CAD application may identify differences between the review and project drawings and provide a display of the review drawing were differences between the two drawings are highlighted to convey at-a-glance what elements in the review drawing have been modified relative to the project drawing.

### BACKGROUND OF THE INVENTION

1. Field of the Invention

The present invention generally relates to computer software. More specifically, the present invention relates to a method and system for the coordinated drawing review of related CAD drawings.

2. Description of the Related Art

The term computer-aided design (CAD) generally refers to a broad set of computer software applications used by a variety of, artists, animators, designers, engineers and other professionals to create computer images such as construction blueprints, CAD models, animation sequences, CGI sequences, 3D models, and graphic displays, etc. In many design projects, CAD drawings are developed, by teams of individuals and may go through multiple revisions before the drawings for a given design project are finalized. Frequently, one team member may make changes ore revisions to a drawing included in a design project that may affect other aspects of the design. Revisions may include changes to the geometric properties of a drawing object (e.g., changes to the existence, thickness, or position of a wall, or the addition or removal of windows and doors in the wall). However, revisions may also include changes to the metadata associated with a drawing object (e.g., changes to the materials, manufacturer, or drawing style associated with a drawing object). When displayed by a CAD application, changes to the metadata associated with a drawing object may not be directly visible in the drawing.

In any case, it is important that revisions to a CAD drawing be thoroughly vetted before being incorporated into the overall design project. Thus, some CAD applications allow for drawing review by providing a side-by-side display of multiple versions of a drawing. However, this approach relies on a user “spotting” differences between the original and modified drawing. Further, a side-by-side display may not indicate that changes have been made to the metadata associated with a given drawing object.

Another approach taken by some CAD applications is to simply overlay one drawing on top of another. This approach may be effective in showing that geometric elements of a drawing have changed, but distinguishing whether a given drawing element is part of the original version or the revision can quickly become difficult. Further, like the side-by-side approach, a simple overlay may not indicate that changes have been made to the metadata associated with a given drawing object.

This review process is further complicated as CAD drawings are often compound documents that include both internal drawing objects and “placed objects” (i.e., a cross-reference to an object in another drawing). When revisions to cross-referenced drawing objects are reviewed, the reviewer needs to trace through all of the related drawings to properly review a drawing. This situation can become extremely frustrating in large projects where the drawings for a single project may include hundreds of files in multiple directories. Nevertheless, the correct relationship between drawings within a related hierarchy needs to be established or the comparison and review may become inaccurate or incomplete. Because of this complexity, users often simply copy a revised drawing into a design project without fully reviewing how the changes may affect the overall design project in related or cross-referenced files.

Accordingly, there remains a need in the art for a way for users to easily and efficiently manage and coordinate the review of the various drawings of a design project.

### SUMMARY OF THE INVENTION

Embodiments of the invention provide methods for performing a coordinated drawing review of related CAD drawings. Typically, a user may initiate a coordinated drawing review session by selecting a folder containing project drawings and a folder containing review drawings. In response a CAD application may be configured to identify which drawings in the project and review folder correspond to one another for purposes of comparison. For example, a drawing in the review folder may represent a new version of a drawing in the project folder. Thereafter, a user may select a review drawing to compare with a matched project drawing and initiate a drawing review session. During a review session, the review drawing may be displayed in a manner that provides a visual indication of differences between the review drawing and the matched project drawing. For example, drawing objects in the review drawing that are modified, missing, or newly added (relative to the matching drawing in the project folder), may be displayed using different colors. One color scheme may display new elements in green, modified elements in yellow, and removed or missing elements in red. However, users may set the color scheme as a matter of preference.

Additionally, drawing objects being reviewed (whether modified, missing, removed, or new) may be assigned a review status of “pending” until the user actually reviews the changes, at which time the review status of an object may be changed to “reviewed.” This allows users to review systematically and completely all the differences between a review drawing and a corresponding project drawing. Further, a list of modified objects may also be displayed, allowing a user to select and view specific changes by selecting an element in the list. The list of modified object list may also provide an element by element comparison of the attributes or properties of a drawing object in both the review and project drawing.

Advantageously, by providing both a graphical and a textual indication of changes in the display of the review drawing, the user may systematically review the differences between drawing objects in the review drawing and the drawing objects in a related project drawing. Further, by marking objects with a “pending” review status, the user may readily ascertain whether changes to a particular drawing object has (or has not) been reviewed. Thus, the process of reviewing revisions to a set of related CAD drawings may be more efficient as well as more accurate and complete.

One embodiment of the invention includes a method for performing a coordinated drawing review to compare differences between a first CAD drawing and a second CAD drawing. The method generally includes receiving a selection of the first CAD drawing and the second CAD drawing and comparing a set of drawing objects in the first CAD drawing with a set of drawing objects in the second CAD drawing. For each drawing object in the first CAD drawing and in the second CAD drawing a comparison status for the drawing object may be determined. The method also includes displaying the first CAD drawing, wherein each drawing object in the first CAD drawing is displayed to indicate the comparison status

Another embodiment includes a method for reviewing differences between a first CAD drawing and a second CAD drawing. The method generally includes specifying a selection of the first CAD drawing and specifying a selection of the second CAD drawing. The method also includes invoking a comparison routine configured to compare a set of drawing objects in the first CAD drawing with a set of drawing objects in the second CAD drawing, wherein the comparison routine is configured to determine a comparison status for each drawing object in the first CAD drawing and in the second CAD drawings and to display the first CAD drawing, based on the comparison status of the drawing objects.

Still another embodiment of the invention includes computer-readable media storing instructions for performing the previously described methods.

### BRIEF DESCRIPTION OF THE DRAWINGS

FIG. 1 is a block diagram illustrating a system that includes elements of a CAD application that may be used during a drawing review session, according to one embodiment of the invention.

FIG. 2 illustrates a screenshot of a graphical user interface that shows an example of a setup tool used to initiate a coordinated drawing review session, according to one embodiment of the invention.

FIG. 3A illustrates a screenshot of a graphical user interface that shows an example of a review tool used during a coordinated drawing review session, according to one embodiment of the invention.

FIG. 3B illustrates a screenshot of a graphical user interface used to specify which drawing objects should be reviewed during a coordinated drawing review session, according to one embodiment of the invention.

FIG. 4 illustrates a method for performing a coordinated drawing review, according to one embodiment of the invention.

FIG. 5 illustrates a method for comparing drawing objects in related CAD drawings, according to one embodiment of the invention.

FIG. 6 illustrates a screenshot of graphical user interface display that shows a coordinated drawing review session, according to one embodiment of the invention.

### DETAILED DESCRIPTION OF THE PREFERRED EMBODIMENTS

Embodiments of the invention provide methods for performing coordinated drawing review of related CAD drawings. In general, a user may select a review drawing to compare with a project drawing. Once selected a CAD application may identify differences between the review and project drawings and provide a display of the review drawing were differences between the two drawings are highlighted to convey at-a-glance which elements in the review drawing have been modified relative to the project drawing.

Embodiments of the invention are described herein using a CAD application used to create a set of related CAD drawings for a construction project. However, the invention is not limited any particular CAD environment or to any particular type of CAD drawings. Rather, embodiments of the invention may be adapted for use with a broad variety of including, architectural drawings (or portions thereof) such as a blueprint or scaled drawing of a construction project, rendered digital images used in a CGI sequence, such as a frame or scene used for an animation project, 2D or 3D digital models or drawings, to name but a couple examples.

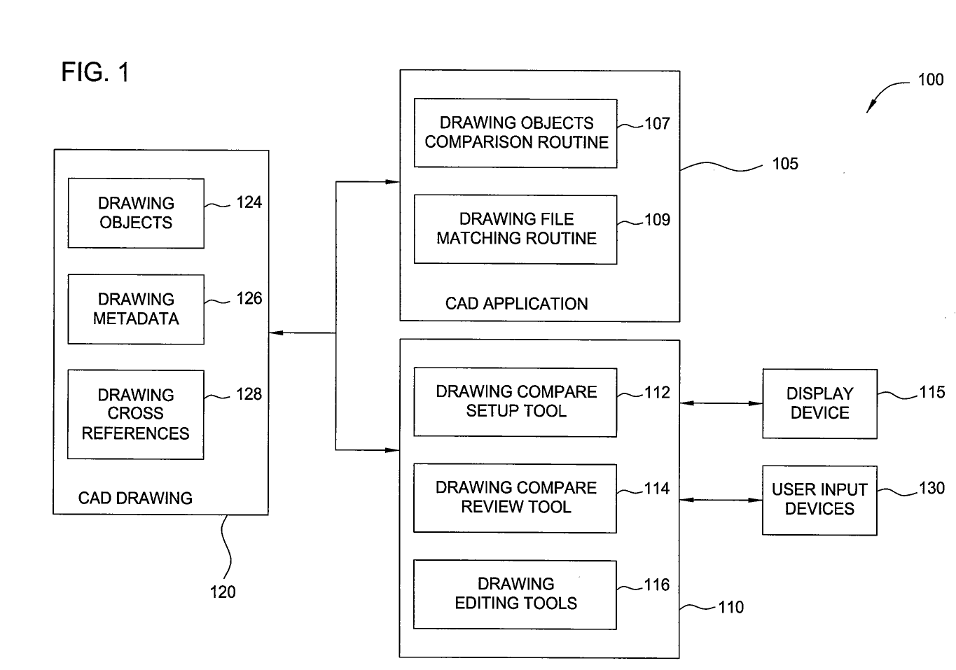

FIG. 1 is a block diagram illustrating a system 100 that includes components of a CAD application 105 that may be used during a drawing review session, according to one embodiment of the invention. In one embodiment, the components illustrated in system 100 include computer software applications executing on existing computer systems, e.g., desktop computers, server computers, laptop computers, tablet computers, and the like. The software applications described herein, however, are not limited to any particular computing system and may be adapted to take advantage of new computing systems as they become available.

Additionally, the components illustrated in system 100 may be software applications executing on distributed systems communicating over computer networks including local area networks or large, wide area networks, such as the Internet. For example, a graphical user interface 110 may include a software program executing on a client computer system at one physical location communicating with CAD application 105 at another physical location. Also, in one embodiment, CAD application 105 and graphical user interface 110 may be provided as an application program (or programs) stored on computer readable media such as a CD-ROM, DVD-ROM, flash memory module, or other tangible storage media.

As shown, the system 100 includes, without limitation, CAD application 105, graphical user interface 110, a CAD drawing 120, user input devices 130, and a display device 115. In one embodiment, CAD application 105 is configured to allow users interacting with GUI interface 110 to compose a CAD drawing 120. Accordingly, CAD application 105 and GUI interface 110 may include routines or instructions allowing users to create, edit, load, and save CAD drawing 120. In one embodiment, the Architectural Desktop application program (and associated utilities) available from Autodesk®, Inc. may be used. Those skilled in the art will recognize, however, that the components shown in FIG. 1 are simplified to highlight aspects of the present invention and that a typical CAD application 105 and GUI interface 110 may include a broad variety of additional tools and features used to compose and manage CAD drawing 120.

Illustratively, CAD application 105 includes a drawing objects comparison routine 107 and a drawing file matching routine 109. In one embodiment, matching routine 109 is used to identify related CAD drawings. For example, if a user receives new versions of drawings included in an existing design project, matching routine 109 may be used to identify corresponding versions of such drawings currently included in the design project. Alternatively, users may specify which drawings to compare to one another for purposes of a project review session.

Once two drawings are identified, comparison routine 107 may be used to identify new, modified, or removed drawing objects in the review drawing. In one embodiment, comparison routine 107 may be configured to identify differences between a project drawing and a matching review drawing. In one embodiment, the differences may be used to generate an object report list. Objects that are new, missing, or modified in the review drawing may be collected in the object report list and presented to the user. Additionally, comparison routine 107 may be configured to gather the different properties that are modified between the compared objects. In one embodiment, the editor window displaying a given drawing may colorize each element in the review drawing based on the comparison result. Providing an “at-a-glance” indication of differences between the review drawing and a matching project drawing.

Graphical user interface (GUI) 110 may include tools used to setup and perform a coordinated review. As shown, graphical user interface 110 includes setup tool 112, review tool 114, and drawing editing tools 116. Drawing tools 116 may provide interactive GUI elements used to compose, edit, modify and/or display CAD drawing 120. Setup tools 112 and review tool 114 may provide users with interactive GUI elements used to setup and perform a coordinated drawing review for different versions of a particular CAD drawing.

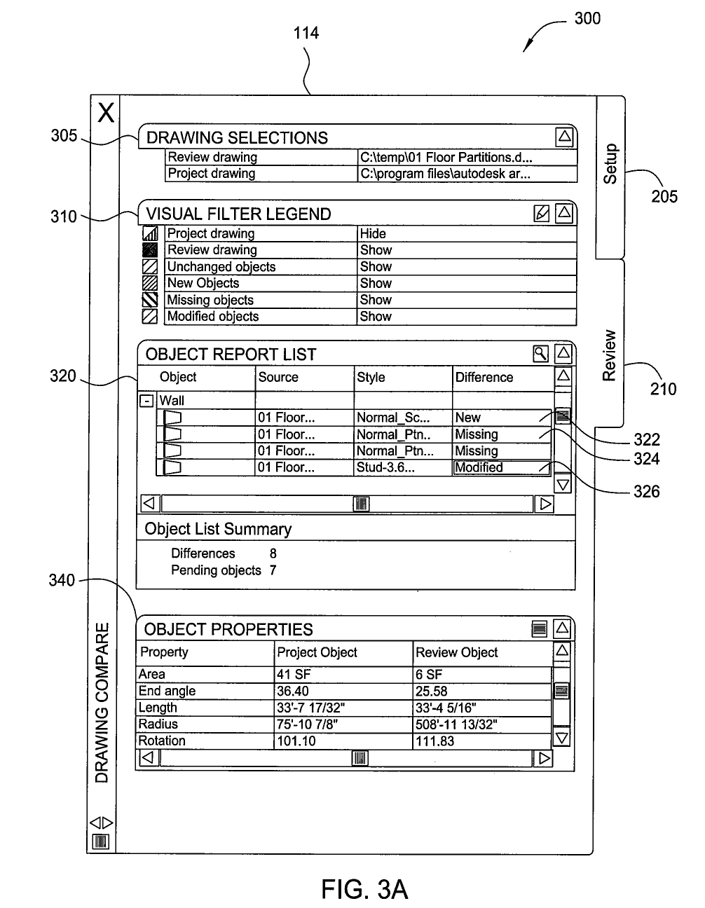

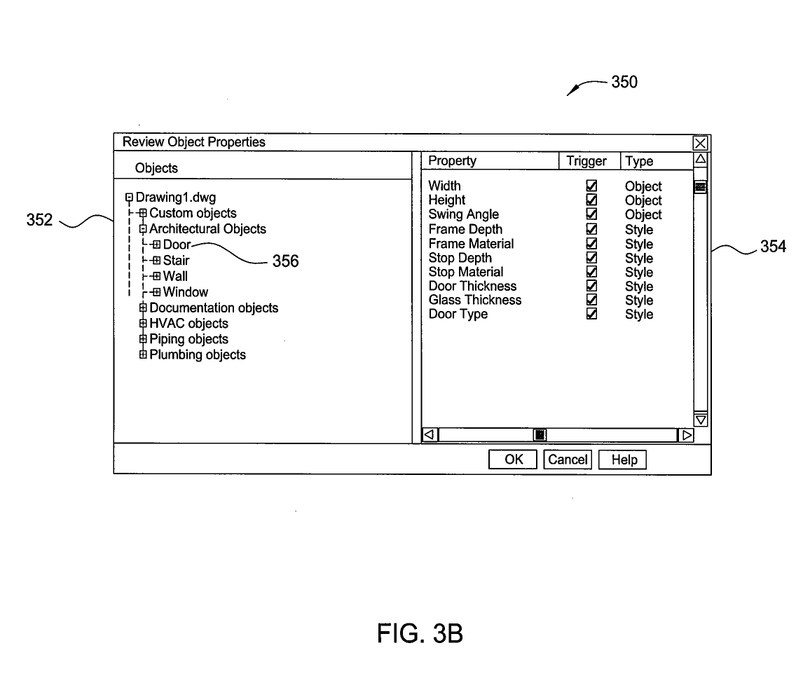

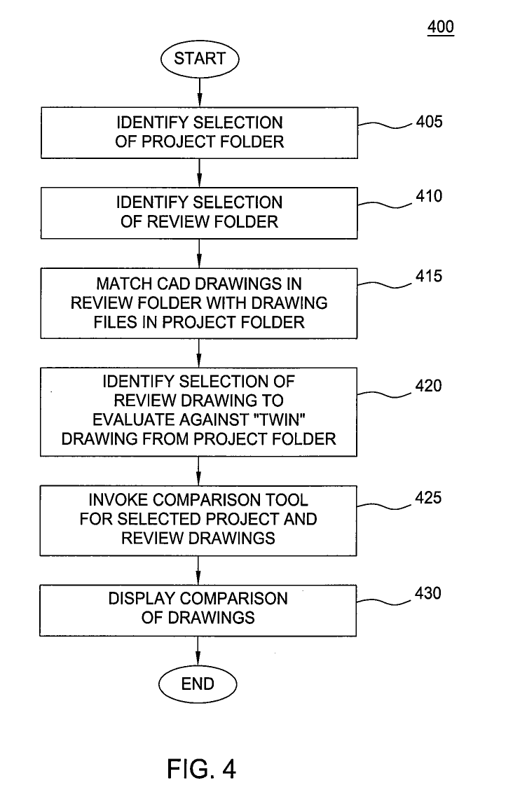

In one embodiment, setup tool 112 may be used to select a folder containing a set of project drawings and a folder containing a set of review drawings. The project folder includes a collection of drawings related to a design project and the review folder may be any folder containing drawings to compare against the drawings of the project folder. FIGS. 3 and 4 provide an example of setup tool 112 and review tool 114, respectively.

CAD drawing 120 is shown to include drawing objects 124, drawing metadata 126, and drawing cross-references 128. Drawing objects 124 represent the design elements included in CAD drawing 120. In an architectural drawing, for example, common drawing objects 124 may include elements such as doors, walls, and windows, etc. Of course, for other applications, the relevant set of drawing objects 124 typically differs.

Drawing metadata 126 generally includes information stored with CAD drawing 120 about drawing objects 124. For example, a door in one CAD drawing may have metadata 126 indicating a certain material, color, supplier, object style, or other metadata associated with an instance of a door object in that CAD drawing. Also CAD drawing 120 may be identified using a drawing ID generated for the drawing by CAD application 105. Generally, drawing IDs are unique across different drawings, but different versions or iterations of the same drawing may use the same drawing ID. Additionally, drawing metadata 126 may include a handle used to identify each drawing object 124 included in CAD drawing 120. Thus, a CAD drawing may have its own drawing ID, and each instance of a drawing element in the drawing may have a handle used to identify the drawing element in that CAD drawing. In one embodiment, comparison routine 107 may compare drawing IDs to identify drawings that correspond to one another (and then to compare elements within different versions of a drawing based on object handles) during a coordinated drawing review session.

Drawing cross-references 128 represent elements of CAD drawing 120 that may be present in another drawing. For example, consider a design project associated with a multi-story building. In such a case, separate drawings may be used to represent each individual floor, and the drawing for each floor may include a cross-reference 128 to a common structural floor plan. CAD drawing 120 is commonly said to be a “host” of drawings referenced by cross references 128. Conversely, CAD drawing 120 may itself be the target of a cross-reference in another drawing. That is, CAD drawing 120 may be “hosted” in another drawing. Additionally, cross-references 128 included in CAD drawing 120 may be nested multiple layers deep. In other words, CAD drawing 120 may include a cross-reference to another drawing which itself includes cross-references to still other drawings. When comparing a review drawing that includes cross-references 128, the cross-referenced drawings may be “pulled in” as part of a coordinated drawing review session to provide a comprehensive comparison.

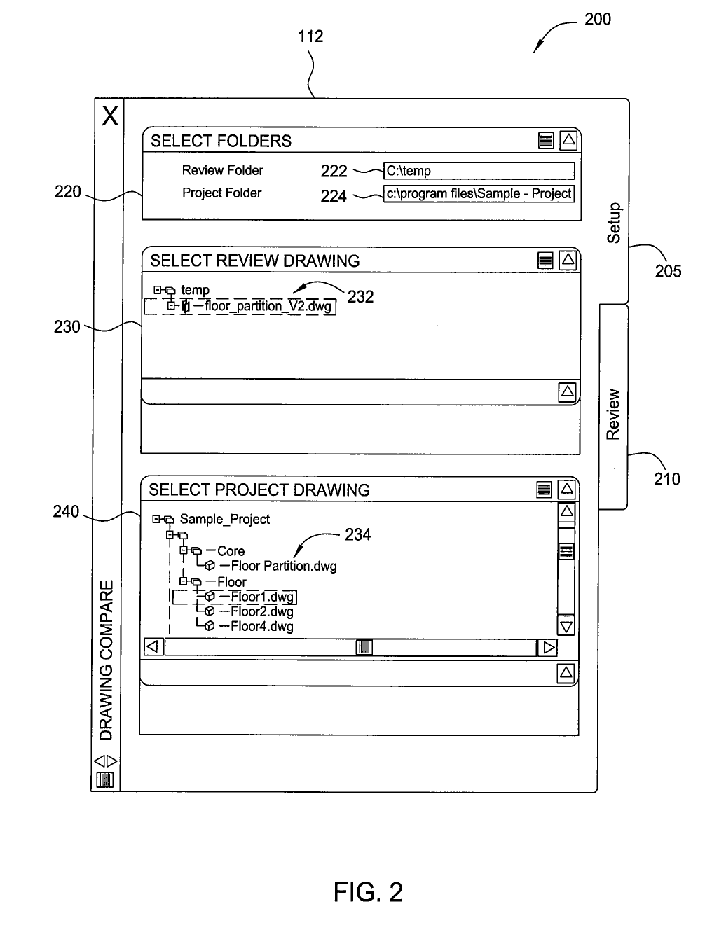

FIG. 2 illustrates a GUI screenshot 200 displaying an example of setup tool 112 used to initiate a coordinated drawing review session, according to one embodiment of the invention. As shown, setup tool tab 205 is selected. Setup tool 112 includes a panel 220 used to identify a project folder and a review folder, a panel 230 used to display a hierarchy of review drawings in the review folder, and a panel 240 used to a display a hierarchy of drawings in the project folder. Illustratively, panel 220 includes text boxes 222 and 224 in which a user may specify the review folder and project folder to use in a coordinated review session. For example, a user may receive new versions of drawing files from a designer and need to review changes before merging the new versions into the project folder. In such a case, the user may copy the new drawing files to a temporary folder and select this folder when setting up a coordinated drawing review session (e.g., the “temp” review folder listed in text box 222). The user may also select the project folder containing the project drawings (e.g., the “sample-project” folder listed in text box 224).

Panel 230 shows a hierarchy of drawings included in the review folder specified in text box 222. Similarly, Panel 240 shows a hierarchy of drawing files included in the project folder specified in text box 224. In one embodiment, a user may initiate a coordinated drawing review session by selecting the project and review folders. Once selected, CAD application 105 may be configured to match drawing files in the review folder with files in the project folder and to display a list of matching files from these folders in panels 230 and 240. For example, CAD application 105 may invoke matching routine 109 to identify which drawing files in the project folder correspond to drawing files in the review folder. Alternatively, the user may specify matching between drawings or folders. For example, setup tool 112 may be configured to allow the user to establish, on a file-to-file basis or a file-to-project folder basis, a matching between a set of selected drawing files.

Illustratively, panel 230 displays a “Select Review Drawing” tree 232 that shows the drawings available in the review drawing folder and panel 240 displays a “Select Project Drawing” tree 234 that shows the matching drawings in the project drawing folder. In one embodiment, panel 230 allows the user to select a review drawing to be evaluated against a matching project drawing. Further, because a review drawing may be hosted in multiple drawings in the project folder, drawings that host the review drawing are also included in tree 234. For example, panel 230 shows a single review drawing named “floor_partition_v2.dwg.” At the same time, panel 240 shows a matched drawing “floor_partition.dwg.” This latter drawing may represent the prior version of the “floor_partition_v2.dwg” drawing. Additionally, each of the “Floor1.dwg,” “Floor2.dwg,” “Floor3.dwg,” and “Floor4.dwg” drawing files in tree 234 are matched to the “floor_partition.dwg” review drawing. This may occur because the “floor_partiton.dwg” drawing is hosted by each of the individual floor drawings. Thus, in addition to allowing users to compare changes made in the review drawing with other versions of that drawing in the project folder, embodiments of the invention also allow users to compare the review drawing in the context of any drawing which hosts the review drawing. This allows users to perform a complete drawing review before integrating a review drawing into the project folder 220.

FIG. 3A illustrates a GUI screenshot 300 showing an example of review tool 114, according to one embodiment of the invention, where review tool 114 may present the user with the settings and information relevant to a review session for a selected review and project drawing. As shown, the review tool tab 210 is selected and review tool 114 includes a drawing selection panel 305, a visual filter legend panel 310, an object report list panel 320, and an object properties panel 340. Drawing selection panel 305 shows the review drawing and project drawing being compared as part of a coordinated drawing review session. As described above, the drawings may be selected by the user interacting with setup tool 112.

Visual filter legend panel 310 specifies how information from the comparison of the review drawing and project drawing is displayed to the user. In one embodiment, the panel 310 may allow the user to select whether to show or hide a display of the project or review drawings and/or whether to show objects having a “new,” status 322 “missing,” status 324 or “modified” status 326. Additionally, panel 310 indicates the color used to display a drawing object based on that object's status as determined by comparison routine 107. In addition to indicating on object status, the drawing objects may also have dual color swatches to indicate a “pending” or “reviewed” status of an object.

Object report list panel 320 presents the user with a list of differences between the review and project drawings identified by comparison routine 107. As shown, the object report list provides a list of drawing objects grouped in the report list by object type, where differences for a “wall” object are displayed. In one embodiment, each drawing object listed in the object report list may be associated with a review status of “pending” or “reviewed.” Objects with a “pending” status may be displayed with bolded text and objects with a “reviewed” status may be displayed with regular text. This allows users to focus on changes that have not yet been reviewed. Further, when the user selects one of the objects from the object report list, the display of the drawing by editor 116 may pan to the selected object, and the object properties displayed in panel 340 may be updated to show the differences identified by the comparison routine 107.

FIG. 3B illustrates a graphical user interface used to specify which drawing objects should be reviewed during a coordinated drawing review session, according to one embodiment of the invention. More specifically, FIG. 3B shows an example configuration for a review object properties browser 350. The properties browser 350 allows users to specify which object properties will be reported in the review mode. For example, a reviewer may desire to limit a coordinated drawing review session to reviewing changes to specified objects, or properties of objects.

As shown, the left panel 352 displays a list of drawing objects in “drawing1.dwg” organized by object type. In this example, the door object 356 is selected and, accordingly, right panel 354 of browser 350 shows a list of properties related to door objects. In one embodiment, multiple object types may be selected. For example, a user may select to show properties for both door object 356 as well window, and wall objects. In one embodiment, if more than one object type is selected, then the common properties of those objects will be displayed in right panel 354.

Illustratively, right panel 354 includes a property name, a check box to activate property reporting in the review mode for the property, and a property type ((e.g., geometric properties or metadata properties). Properties in right panel 354 may be sorted on any of the columns in the panel. Further, properties browser 350 may be configured to allow multiple sorts. (e.g., first sort on the check/un-check state and then alphabetically on the result of this fist sort).

Changes are made to the review mode settings may be saved when a user exits this dialog by pressing the “OK” button.” Note, the comparison routine used to identify drawings may function independently of the filters specified by users interacting with properties browser 350. In other words, comparison routines may be configured to checks all properties for all object types and only display results for objects specified in the properties browser 350.

FIG. 4 illustrates a method 400 for performing a coordinated drawing review, according to one embodiment of the invention. Persons skilled in the art will understand that any system configured to perform the method 400 shown in FIG. 4, in any order, is within the scope of the present invention.

The method begins at step 405 where the user identifies a selection of a project folder to use in a coordinated drawing review session. At step 410, the user identifies a selection of a review folder to use in a coordinated drawing review session. For example, the setup tool 112 illustrated in FIG. 3 may be used to specify the selection of the review and project folder. At step 415, CAD drawings in the review folder may be matched with CAD drawings in the project folder. For example, as described above, each CAD drawing may include a drawing ID. Matching routine 109 may use this information to identify drawings in the project folder that match a review drawing. For example, two versions of the same drawing with the same drawing ID may represent different iterations of the same drawing. In addition to a direct match between different versions of the same CAD drawing, matches may occur between a review drawing and a project drawing that hosts the review drawing. At step 420, the user may select a review drawing to use for a coordinated review session. Additionally, if the selected review drawing is “hosted” in multiple project drawings, the user may also specify which drawing from the project drawings to use in the drawing review session.

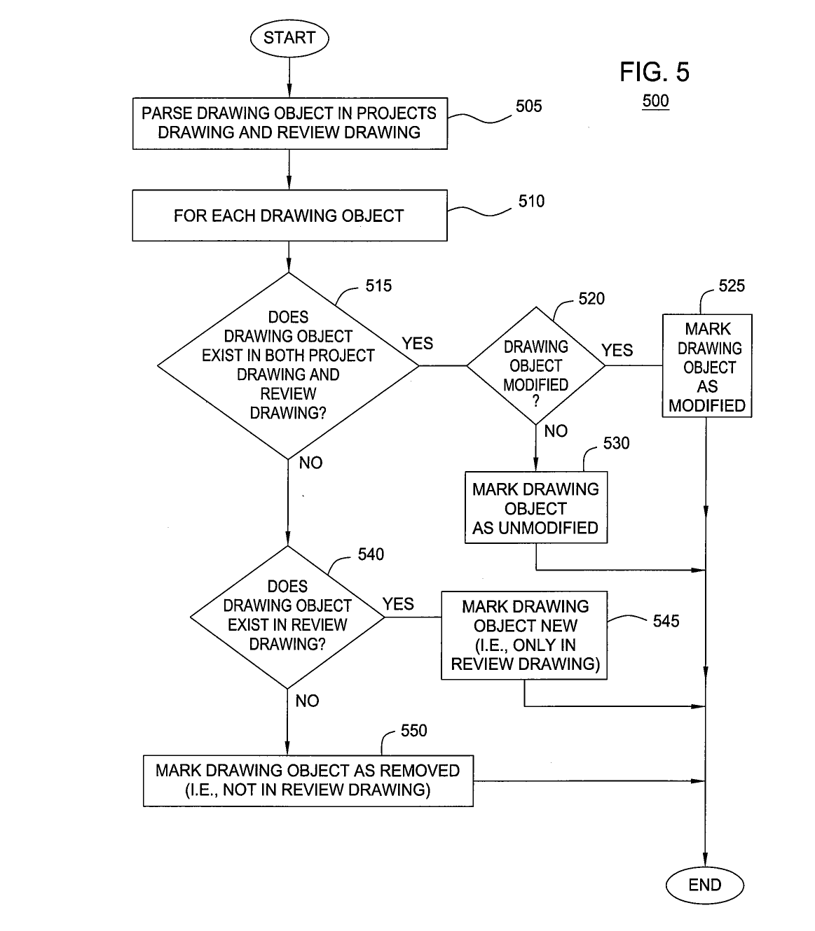

At step 425, once the selected project and review drawings are identified, differences between the selected review project and review drawing may be identified. For example, comparison routine 107 may be invoked to compare the selected project and review drawings. FIG. 5, described below, illustrates an example of the operations of comparison routine 107. At step 430, the differences between the review and project drawings identified at step 425 may be presented to the user. This may include, among other things, presenting an object report list like the one shown in panel 320 of FIG. 3 as well as presenting a display of the review drawing in drawing editor 116 on display device 115 where the review drawing is rendered to convey differences between the review and project drawings, using the colors shown in visual filter legend 310.

FIG. 5 illustrates a method 500 for comparing drawing objects in related CAD drawings, according to one embodiment of the invention. Persons skilled in the art will understand that any system configured to perform the method 500 shown in FIG. 5, in any order, is within the scope of the present invention. In one embodiment, the method 500 may be performed by comparison routine 107 to compare drawing objects in a review drawing with the objects present (or not present) in a matching project drawing.

As shown, the method begins at step 505 where the comparison routine 107 parses the elements in the project drawing and review drawing. At step 510, once parsed, the comparison routine 107 may be configured to determine the status of each drawing object in the review drawing. At step 515, comparison routine 107 may be configured to determine wither a given drawing object is preset in both the project drawing and review drawing being compared. If so, then at step 520, comparison routine 107 determines whether the drawing object is modified. In one embodiment, this determination may be made by a property by property comparison between the instance of the drawing object in the review drawing and the corresponding instance of the drawing object in the project drawing. If the drawing object being evaluated has been modified, then at step 525, the comparison routine 107 may be configured to set the status of this drawing object to “modified.” Further, comparison routine 107 may record what properties, elements, or attributes of the drawing object differ between the project and review drawings. Otherwise, if the object is unchanged, then at step 530 the status for the object may be set to “unchanged.”

Returning to step 515, if the drawing object being evaluated is not present in both the project and review drawing, then at step 540, comparison routine 107 may determine whether the drawing object exists only in the review drawing. If so, then at step 545, the drawing status for this object may be set to “new.” Otherwise, where the drawing object is present in the project drawing, but not in the review drawing, then the object status may be set to “removed” at step 550.

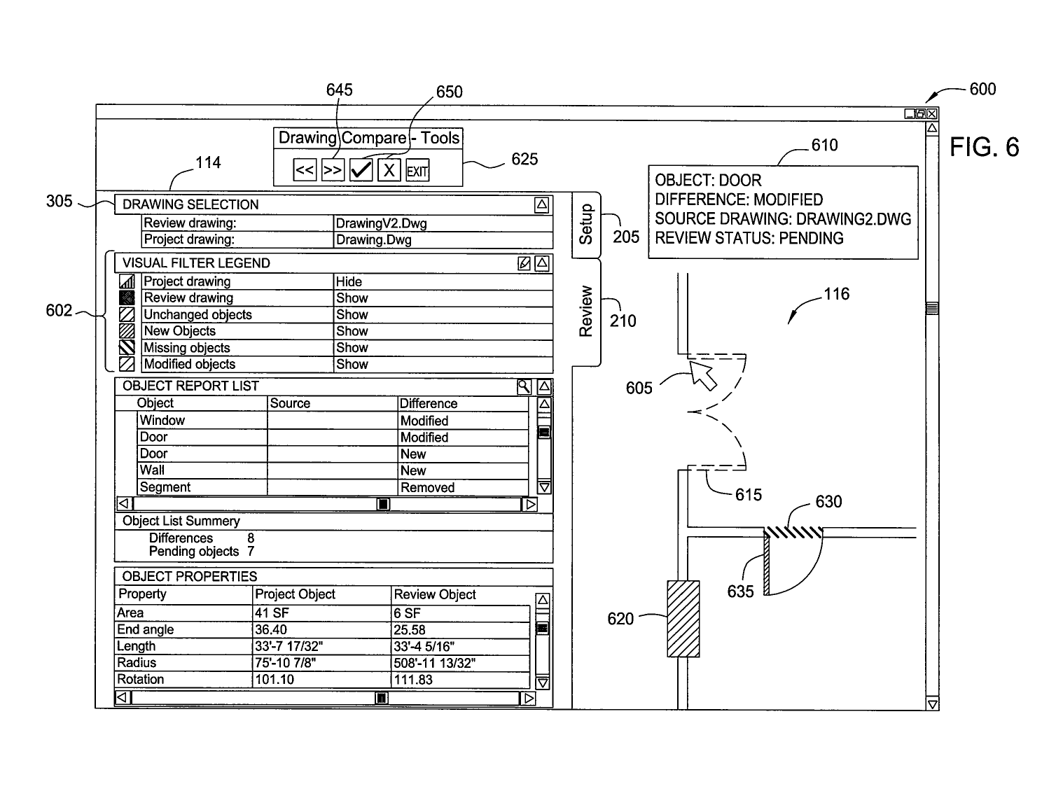

FIG. 6 illustrates a GUI screenshot 600 displaying a coordinated drawing review session, according to one embodiment of the invention. As shown, screenshot 600 includes a display of review tool 114, editing display 116, a drawing compare tool 625, a tool-tip 610, a modified window 620, a removed wall segment 630 and a newly added door object 635.

Each object may be colored based on the color selections specified in visual filter legend 602. The different colors may specify the status of a drawing element as being new, missing, modified, or removed, relative to the objects in the project drawing and review drawing being reviewed. Additionally, the colors may further indicate the review status of the drawing elements. Using a review status of “pending” or “reviewed” may facilitate the review process by allowing a user to only focus on items that have yet to be reviewed.

In one embodiment, each object in the review drawing may be displayed according to color scheme specified in visual filter legend 602. For example, removed wall segment 630 is shown using the color specified for removed drawing objects. Similarly, newly added door object 635 is shown using the color specified for new objects and modified window object 620 is displayed using the color for modified objects. Thus, users may identify not only what elements have been modified, but also what type of difference has been identified between a drawing object in the project drawing and one in the review drawing.

Further, the display may allow users to easily obtain information related to any given difference indicated by the display of the review drawing. For example, mouse cursor 605 is shown hovering over modified door object 615, and in response, tool-tip 610 is displayed to show the review status and difference for modified door object 615. In addition to displaying the review door 615 (i.e., the door in a modified form), when the mouse cursor 605 is moved to hover over a given drawing object, the display may also show a representation of the corresponding door in the project drawing (i.e., the door in an unmodified form) allowing for an “overlay” comparison between the modified door object and the original door object. Further the colors for the original door (from the project drawing) and the modified door (from the review drawing) may correspond to the colors set for original and modified door objects (e.g., the colors shown in visual filter legend 602). Thus, in addition to providing an “at-a-glance” indication of differences between the review drawing and a matching project drawing, the specific review status of any drawing object may readily be ascertained.

Drawing compare tools 625 may allow the user to systematically navigate between changes listed in the object report list and to approve or reject changes. For example, next button 645 may be used to navigate to the next drawing object in the object report list with a review status of “pending.” Moreover, accept/reject buttons 650 may be used to merge revisions in a review drawing into a matching project drawing. In addition to the visual presentation of the drawing objects in editing display 116, the changes are also shown in the object report list, allowing a user to select to review an item of interest. In one embodiment, upon selection of a drawing object, the display of the review drawing in editing display 116 may automatically pan to the selected drawing object. In addition, the object properties panel 340 may be updated with an element by element comparison of a selected drawing object.

Advantageously, by providing both the graphical and textual indication of changes in the display of a review drawing, the user can systematically review all drawing objects, and further, may readily ascertain whether an object has (or has not) been reviewed. Thus, the review process of reviewing a set of related CAD drawings may be both more efficient as well as being more accurate and complete.

While the foregoing is directed to embodiments of the present invention, other and further embodiments of the invention may be devised without departing from the basic scope thereof, and the scope thereof is determined by the claims that follow.

What is claimed is:

1. A method for performing a coordinated drawing review to compare differences between a first computer-aided design (CAD) drawing and a second CAD drawing, comprising:
receiving a selection of the first CAD drawing and the second CAD drawing;
comparing a set of drawing objects in the first CAD drawing with a set of drawing objects in the second CAD drawing;
for each drawing object in the first CAD drawing and in the second CAD drawing, determining a comparison status for the drawing object;
displaying the first CAD drawing, wherein each drawing object in the first CAD drawing is displayed to indicate the comparison status.

2. The method of claim 1, wherein the comparison status for each object in the first drawing reflects the whether drawing object has been modified, removed, or is unchanged relative to the set of drawing objects in the second CAD drawing, and wherein the comparison of each drawing object in the second CAD drawing reflects whether the drawing object has been modified added or is unchanged relative to the set of drawing objects in the first CAD drawing.

3. The method of claim 1, wherein the comparison status reflects a modification to the metadata associated with a given drawing object, and wherein the given drawing object is displayed to provide a visual indication that the metadata associated with the given drawing object has also been modified.

4. The method of claim 1, wherein displaying the first CAD drawing comprises rendering the drawing objects using a color associated with the determined comparison status.

5. The method of claim 1, wherein the second CAD drawing includes a cross-reference to a drawing object contained in a third CAD drawing.

6. The method of claim 1, wherein the first CAD drawing is selected from a folder of review drawings and wherein the second CAD drawing is selected from a folder of drawings associated with a design project.

7. The method of claim 1, wherein each drawing object is associated with a review status indicating whether the comparison status of the drawing object has been reviewed.

8. The method of claim 1, wherein displaying the first CAD drawing comprises displaying a graphical representation of the drawing objects in the first CAD drawing and a textual indication of the comparison status of the drawing objects in the first CAD drawing.

9. A computer-readable medium storing instructions for performing a coordinated drawing review to identify differences between a first computer-aided design (CAD) drawing and a second CAD drawing, including instructions for performing the steps of:
receiving a selection of the first CAD drawing and the second CAD drawing;
comparing a set of drawing objects in the first CAD drawing with a set of drawing objects in the second CAD drawing;
for each drawing object in the first CAD drawing and in the second CAD drawing, determining a comparison status for the drawing object;
displaying the first CAD drawing, wherein each drawing object in the first CAD drawing is displayed to indicate the comparison status.

10. The computer-readable medium of claim 9, wherein the comparison status for each object in the first drawing reflects the whether drawing object has been modified, removed, or is unchanged relative to the set of drawing objects in the second CAD drawing, and wherein the comparison of each drawing object in the second CAD drawing reflects whether the drawing object has been modified added or is unchanged relative to the set of drawing objects in the first CAD drawing.

11. The computer-readable medium of claim 9, wherein the comparison status reflects a modification to the metadata associated with a given drawing object, and wherein the given drawing object is displayed to provide a visual indication that the metadata associated with the given drawing object has also been modified.

12. The computer-readable medium of claim 9, wherein displaying the first CAD drawing comprises rendering the drawing objects using a color associated with the determined comparison status.

13. The computer-readable medium of claim 9, wherein the second CAD drawing includes a cross-reference to a drawing object contained in a third CAD drawing.

14. The computer-readable medium of claim 9, wherein the first CAD drawing is selected from a folder of review drawings and wherein the second CAD drawing is selected from a folder of drawings associated with a design project.

15. The computer-readable medium of claim 9, wherein each drawing object is associated with a review status indicating whether the comparison status of the drawing object has been reviewed.

16. The computer-readable medium of claim 9, wherein displaying the first CAD drawing comprises displaying a graphical representation of the drawing objects in the first CAD drawing and a textual indication of the comparison status of the drawing objects in the first CAD drawing.

17. A method for reviewing differences between a first computer-aided design (CAD) drawing and a second CAD drawing, comprising:
specifying a selection of the first CAD drawing;
specifying a selection of the second CAD drawing; and
invoking a comparison routine configured to compare a set of drawing objects in the first CAD drawing with a set of drawing objects in the second CAD drawing, wherein the comparison routine is configured to determine a comparison status for each drawing object in the first CAD drawing and in the second CAD drawings and to display the first CAD drawing, based on the comparison status of the drawing objects.

18. The method of claim 17, wherein the comparison status for each object in the first drawing reflects the whether drawing object has been modified, removed, or is unchanged relative to the set of drawing objects in the second CAD drawing, and wherein the comparison of each drawing object in the second CAD drawing reflects whether the drawing object has been modified added or is unchanged relative to the set of drawing objects in the first CAD drawing.

19. The method of claim 17, wherein the comparison status reflects a modification to the metadata associated with a given drawing object, and wherein the given drawing object is displayed to provide a visual indication that the metadata associated with the given drawing object has also been modified.

20. The method of claim 17, wherein the comparison routine displays the representation of the drawing object using a color associated with the determined comparison status.

21. The method of claim 17, wherein the second CAD drawing includes a cross-reference to a drawing object contained in a third CAD drawing.

22. The method of claim 17, wherein the first CAD drawing is selected from a folder of review drawings and wherein the second CAD drawing is selected from a folder of drawings associated with a design project.

23. The method of claim 17, wherein each drawing object is associated with a review status indicating whether the comparison status of the drawing object has been reviewed.

24. The method of claim 17, wherein displaying the first CAD drawing comprises displaying a graphical representation of the drawing objects in the first CAD drawing and a textual indication of the comparison status of the drawing objects in the first CAD drawing.
